(19) United States
(12) Patent Application Publication
(10) Pub. No.: US 2019/0360571 A1
(43) Pub. Date: Nov. 28, 2019

(54) POWER GENERATING APPARATUS USING HAMMER

(71) Applicant: Dong Hyeon Gwon, Busan (KR)

(72) Inventor: Dong Hyeon Gwon, Busan (KR)

(21) Appl. No.: 16/113,755

(22) Filed: Aug. 27, 2018

(30) Foreign Application Priority Data
May 28, 2018 (KR) 10-2018-0060546

(51) Int. Cl. F16H 47/02; F16H 1/02; F16H 43/00; F03G 3/00

(52) U.S. Cl. CPC F16H 47/02; F03G 3/00; F16H 43/00; F16H 1/02

(57) ABSTRACT

Disclosed is a power generating apparatus using a hammer comprising: a main body including a base body in which an operating fluid is stored, a first inner connecting rod provided to be movable to one side of the base body, and a spring provided at the other side of the base body; a hammer portion of which one side is rotatably coupled to the main body to hit the first inner connecting rod and the other side is connected to the spring; a hammer driving portion which hits the first inner connecting rod by the hammer portion to supply power; a crankshaft portion which rotates by receiving a force for hitting the hammer portion by the hammer driving portion; and a power transmission portion which is connected to the crankshaft portion to rotate together with the crankshaft and connected to a power generator.

### CROSS-REFERENCE TO RELATED APPLICATIONS

This application is based on and claims the benefit of priority to Korean Patent Application No. 10-2018-0060546 filed on May 28, 2018, with the Korean Intellectual Property Office, the disclosure of which is incorporated herein by reference.

### BACKGROUND OF THE INVENTION

### Field of the Invention

The present invention relates to a power generating apparatus, and more particularly, to a power generating apparatus using a hammer that generates power using a hitting force of the hammer.

### Description of the Related Art

Generally, a power transmission apparatus refers to an apparatus that transmits a generated rotational force to a separate component.

That is, the power transmission apparatus may be used as a means for applying a driving force generated in an engine or the like to a wheel, or as a means for converting a driving force generated in a power generator to electric energy. Also, an apparatus of reducing and transmitting the number of revolutions such as a decelerator may be a kind of power transmission apparatus.

In addition, all of the means for transmitting the power by means of indirect contact of various types of gears, chains, and belts from a power source may be referred to as the power transmission apparatus.

An automobile engine, which is used for human life well, rotates a crank using explosive power that touches off an explosion by combining gasoline, electricity, and a compressive force and uses energy generated based on a rotational force of the crank.

On the other hand, in Korea, nuclear power plants are operating in a small land mass. In Korea, it is not assured that there is no possibility of an accident like nuclear power plant accident in Japan. When a nuclear accident occurs, one-third of the country will turn into a dead land, and citizens should consider immigration when the incident occurs. Currently, in Europe including England and Germany, nuclear power and thermal power plants have been removed. In the Europe, alternate power has depended on solar light or wind-driven power using the wind. However, if power consumption is gradually increased, power will be lacking in the future, and other measures are needed to prepare for this situation.

Recently, it is expected that outdoor activities are increased in order to enjoy happy life. Therefore, a functional engine capable of minimizing the consumption of fuel for electric production, which is essential for outdoor activities, is required, and continuous power generation is required by rotating a generator by operating the engine.

The above-described technical configuration is a background technique for assisting the understanding of the present invention, and does not mean a conventional technology widely known in the art to which the present invention belongs.

### SUMMARY OF THE INVENTION

Therefore, an object of the present invention is to provide a power generating apparatus capable of generating power using a hammer.

An aspect of the present invention provides a power generating apparatus using a hammer including: a main body including a base body in which an operating fluid is stored, a first inner connecting rod provided to be movable at one side of the base body, and a spring provided at the other side of the base body; a hammer portion of which one side is rotatably coupled to the main body to hit the first inner connecting rod and the other side is connected to the spring; a hammer driving portion which hits the first inner connecting rod by the hammer portion to provide power; a crankshaft portion which rotates by receiving a force for hitting the hammer portion by the hammer driving portion; and a power transmission portion which is connected to the crankshaft portion to rotate together with the crankshaft and connected to a power generator.

The main body may further include a second inner connecting rod which is movably provided in the base body and receives the force of the first inner connecting rod by the operating fluid stored in the base body; a connecting rod of which one side is provided in the base body to receive the force of the second inner connecting rod and the other side is connected to the crankshaft; and a spring pressing member of which one side is connected to the hammer portion and the other side is provided in the base body to transmit a force for contracting the spring to the spring when the hammer portion rotates.

The main body may further include a support which supports a lower portion of the base body; and a connecting rod housing which is coupled to the base body to support the connecting rod.

The hammer portion may include a hammer connecting rod of which one side is connected to the spring pressing member and the other side is rotatably connected to the support provided in the base body; and a hammer member which is provided at the lower portion of the hammer connecting rod to hit the first inner connecting rod.

The hammer driving portion may include a hammer driving body disposed below the hammer member; and a hammer driving member which is rotatably provided in the hammer driving body and rotated by the power generated by the driving body to rotate the hammer member.

The crankshaft portion may include a crankshaft support body spaced apart from the base body; a crankshaft which is rotatably coupled to the upper portion of the crankshaft support body; a plurality of first bearing housings which is coupled to the crankshaft support body to rotatably support the crankshaft; a plurality of first gears provided in the crankshaft; and a plurality of fly wheels provided in the crankshaft.

The power transmission portion may include a power transmission shaft connected to the power generator; a plurality of second gears which is provided in the power transmission shaft and connected with the plurality of first gears by a connecting member; and a plurality of second bearing housings which rotatably supports the power transmission shaft.

According to the embodiments of the present invention, when the first inner connecting rod of the main body is hit by rotating the hammer portion by the hammer driving portion, the crankshaft is rotated by an operating fluid stored in the main body and an elastic force of the spring to operate the power generator, thereby minimizing the consumption of the fuel and producing the electric power.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a diagram schematically showing a power generating apparatus using a hammer according to an embodiment of the present invention;

FIG. 2 is a diagram schematically showing a main portion of the power generating apparatus using the hammer according to the embodiment of the present invention;

FIG. 3 is a diagram schematically showing a main body, a hammer portion and a crankshaft portion shown in FIG. 1;

FIG. 4 is a diagram schematically showing a connecting rod, a connecting rod housing and a coupler shown in FIG. 1;

FIG. 5 is a diagram schematically showing a state in which the connecting rod and the crankshaft are coupled to each other by the coupler shown in FIG. 1;

FIG. 6 is a diagram schematically showing a part of the crankshaft portion shown in FIG. 1;

FIG. 7 is a diagram schematically showing a state in which a first inner connecting rod shown in FIG. 3 is coupled to a base body;

FIG. 8 is a diagram schematically showing the hammer portion shown in FIG. 1;

FIG. 9 is a diagram schematically showing a state in which a spring is provided inside the base body shown in FIG. 3;

FIG. 10 is a diagram showing the base body shown in FIG. 1 and a support supporting a lower portion of the base body.

FIG. 11 is a diagram schematically showing a hammer hitting body shown in FIG. 1;

FIG. 12 is a diagram showing a state in which a region of a hammer driving member and a crankshaft portion provided with fly wheels are connected to each other by a connecting portion in the present embodiment shown in FIG. 1;

FIG. 13 is a diagram schematically showing a state in which a plurality of present embodiments are connected to each other to provide a power generating plant; and

FIG. 14 is a diagram schematically showing a state in which the present embodiments used for power generation are connected to each other by a belt.

### DETAILED DESCRIPTION OF THE PREFERRED EMBODIMENT

In order to fully understand the present invention, operational advantages of the present invention and objects achieved by implementing the present invention, the prevent invention will be described with reference to the accompanying drawings which illustrate preferred embodiments of the present invention and the contents illustrated in the accompanying drawings.

Hereinafter, preferred exemplary embodiments of the present invention will be described in detail with reference to the accompanying drawings. Like reference numerals illustrated in the respective drawings designate like members.

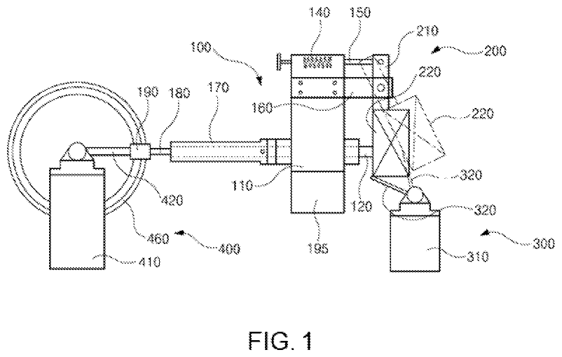

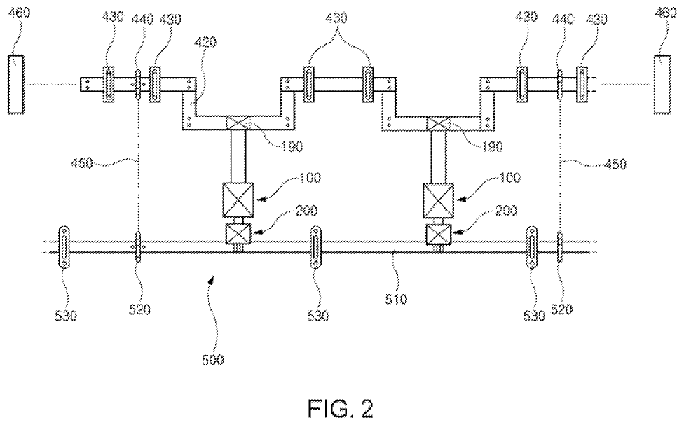

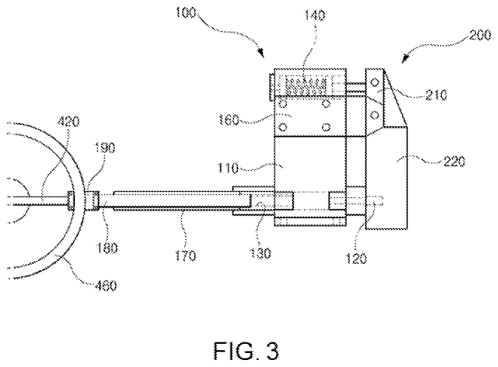

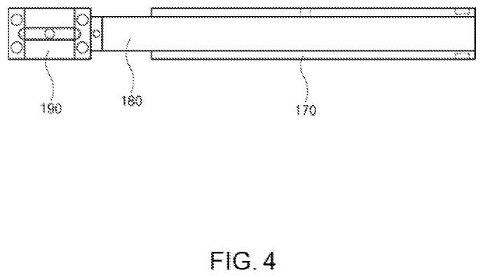

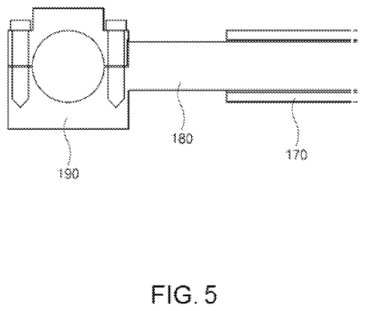

FIG. 1 is a diagram schematically showing a power generating apparatus using a hammer according to an embodiment of the present invention, FIG. 2 is a diagram schematically showing a main portion of the power generating apparatus using the hammer according to the embodiment of the present invention, FIG. 3 is a diagram schematically showing a main body, a hammer portion and a crankshaft portion shown in FIG. 1, FIG. 4 is a diagram schematically showing a connecting rod, a connecting rod housing and a coupler shown in FIG. 1, and FIG. 5 is a diagram schematically showing a state in which the connecting rod and the crankshaft are coupled to each other by the coupler shown in FIG. 1.

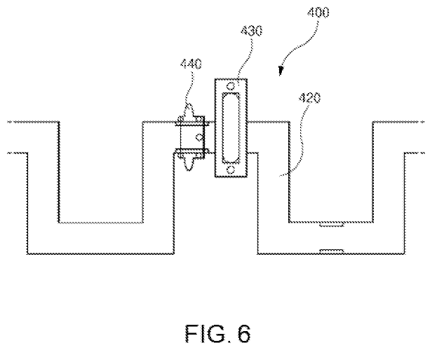

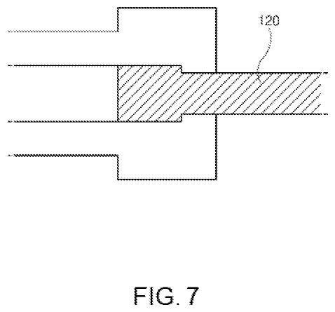

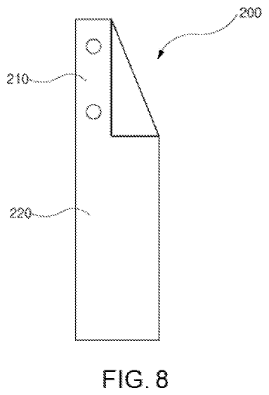

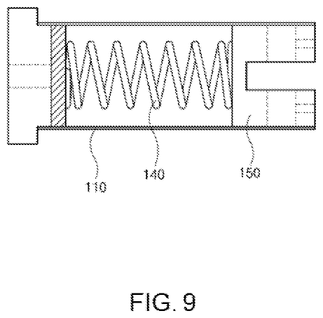

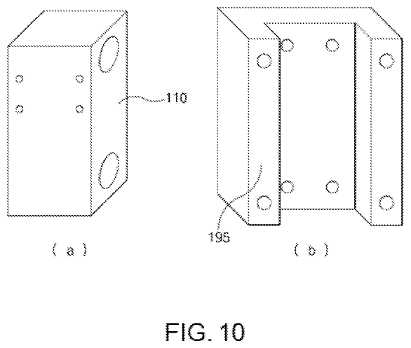

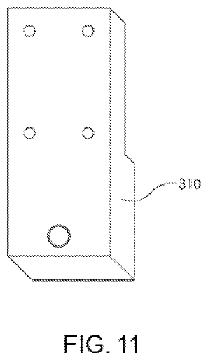

In addition, FIG. 6 is a diagram schematically showing a part of the crankshaft portion shown in FIG. 1, FIG. 7 is a diagram schematically showing a state in which a first inner connecting rod shown in FIG. 3 is coupled to a base body, FIG. 8 is a diagram schematically showing the hammer portion shown in FIG. 1, FIG. 9 is a diagram schematically showing a state in which a spring is provided inside the base body shown in FIG. 3, FIG. 10 is a diagram showing the base body shown in FIG. 1 and a support supporting a lower portion of the base body, and FIG. 11 is a diagram schematically showing a hammer hitting body shown in FIG. 1.

As shown in these drawings, a power generating apparatus 1 using a hammer according to the present embodiment includes a main body 100, a hammer portion 200 which is connected to the main body 100 to hit a first inner connecting rod 120 provided in the main body 100, a hammer driving portion 300 that provides power by hitting the first inner connecting rod 120 by the hammer portion 200, a crankshaft 400 that is connected to the main body 100 to rotate when hitting the crankshaft portion 400, and a power transmission portion 500 which is connected to the crankshaft portion 400 to transmit a rotational force of the crankshaft portion 400 to the power generator.

As shown in FIG. 1, the main body 100 includes a base body 110, a first inner connecting rod 120 that is movably provided at one side of the base body 110, a second inner connecting rod 130 which is movably provided on the base body 110 so as to be disposed on a straight line with the first inner connecting rod 120 and receives the force of the first inner connecting rod 120 by an operating fluid stored in the base body 110, a spring 140 provided at an upper portion of the base body 110, a spring pressing member 150 of which one side is connected to the inside of the base body 110 to press the spring 140 and the other side is connected with the hammer connecting rod 210, a support 160 which rotatably supports the hammer connecting rod 210 to rotate the hammer portion 200, a connecting rod housing 170 of which one side is coupled to the base body 110, a connecting rod 180 of which one side is in contact with the second inner connecting rode 130 to receive a force transmitted to the second inner connecting rod 130 and transmits the force to a crankshaft 420, a coupler 190 coupling the connecting rod 180 to the crankshaft 420, and a support 195 coupled to the lower side of the base body 110 to support the base body 110.

As shown in FIG. 3, an operating fluid, for example, oil generating hydraulic pressure is stored in a lower portion of the base body 110, that is, a region in which the first inner connecting rod 120 and the second inner connecting rod 130 are disposed, and the second inner connecting rod 130 may be moved in a direction of the crankshaft 400 by the operating fluid when the first inner connecting rod 120 is moved.

In the present embodiment, the force generated by hitting the first inner connecting rod 120 by the hammer member 220 may be increased about 2.5 times to the second inner connecting rod 130 through the operating fluid stored in the base body 110. As a result, a force that is about 2.5 times greater than the initial input force may be transmitted to the crankshaft 420. In the present embodiment, for example, an area of the second inner connecting rod 130 which is in contact with the operating fluid in the base body 110, is twice larger than the area of the first inner connecting rod 120 so that the force of about 2.5 times is transmitted to the second inner connecting rod 120.

Specifically, in the case where the diameter of the first inner connecting rod 120 contacting the operating fluid is 16 mm and the diameter of the second inner connecting rod 130 is 40 mm, when the hammer member 220 hits the first inner connecting rod 120, the force of about 2.5 times larger than the initial input force may be transmitted to the crankshaft 420 through the second inner connecting rod 120 by the Pascal's principle.

A sealing member including an oil ring may be provided on the first inner connecting rod 120 and the second inner connecting rod 130 of the main body 100 to prevent the operating fluid from being leaked to the outside of the base body 110.

The spring 140 of the main body 100 may be received in the upper portion of the base body 110, as shown in FIG. 3.

In the present embodiment, based on FIG. 1, the spring 140 may provide a force of hitting the first inner connecting rod 120 by the hammer portion 200 while the spring 140 is contracted when the hammer portion 200 is rotated to the right side by the hammer driving portion 300 and then the spring 140 is expanded.

Also, in the present embodiment, the spring 140 includes a coil spring.

The coupling of the main body 100 is coupled to the end of the connecting rod 180 to bolt-couple the crankshaft 420 to the connecting rod 180, as shown in FIG. 5.

The support 195 of the main body 100 may be detachably bolt-coupled to the base body 110.

As shown in FIG. 1, the hammer portion 200 includes a hammer connecting rod 210 of which one side is rotatably coupled to a support 160, and a hammer member 220 which is provided at the lower side of the hammer connecting rod 210 to hit the first inner connecting rod 120.

In the present embodiment, the hammer portion 200 is rotated by the hammer driving portion 300 at the time of initial operation to hit the first inner connecting rod 120 and may continuously hit the first inner connecting rod 120 for a predetermine time by the operating fluid stored in the base body 110 and the spring 140.

Specifically, when the hammer portion 200 is rotated to the right side based on FIG. 1 by operating the hammer driving portion 300 to hit the first inner connecting rod 120, the pressure applied to the operating fluid stored in the base body 110 is transmitted to the second inner connecting rod 130 to move the connecting rod 180 to the left side based on FIG. 1. The crankshaft 420 is rotated when the connecting rod 180 is moved to the left side, and the rotation of the crankshaft 420 is transmitted to the power transmission portion 500 by the connecting member 450 including a chain to generate the power generator. At this time, the movement of the connecting member 450 in a direction opposite to the hitting direction of the hamper portion 200 may be achieved by the force applied to the second inner connecting rod 130 due to the rotation of the crankshaft 420 and the contraction and expansion of the spring 140. In the present embodiment, when the operation of the hammer portion 200 is stopped after a predetermined time has elapsed, the hammer portion 200 hits the first inner connecting rod 120 by operating the hammer driving portion 300 again to generate electric power.

The hammer driving unit 300 may be disposed below the hammer member 220 to provide power for rotating the hammer portion 200, as shown in FIG. 1.

In the present embodiment, as shown in FIG. 1, the hammer driving portion 300 includes a hammer driving body 310 disposed at a lower portion of the hammer member 220, and a hammer driving member 320 provided to be rotatable by the hammer driving body 310 and rotated by the power generated by the driving body to rotate the hammer member 220.

In the present embodiment, the hammer driving body 310 may rotate the hammer driving member 320 using a known hydraulic pressure as a power source in order to minimize fuel consumption.

The crankshaft portion 400 uses the principle of a crankshaft applied to an automobile and may be connected to the main body 100 by the coupler 190 and rotated clockwise or counterclockwise as shown in FIG. 2.

In the present embodiment, the crankshaft portion 400 includes a crankshaft support body 410 spaced apart from the base body 110, a crankshaft 420 rotatably coupled to the upper portion of the crankshaft support body 410, a plurality of first bearing housings 430 coupled to the crankshaft support body 410 to support rotatably the crankshaft 420, a plurality of first gears 440 provided in the crankshaft 420, a connecting member 450 connecting the plurality of first gears 440 and the power transmission portion 500 and including a chain, and a plurality of fly wheels 460 provided in the crankshaft 420.

As shown in FIG. 2, the power transmission portion 500 is connected to the crankshaft portion 400 by the connecting member 450 and serves to transmit the rotational force transmitted from the crankshaft portion 400 to the power generator.

In the present embodiment, as shown in FIG. 2, the power transmission portion 500 includes a power transmission shaft 510 connected to a power generator (not shown), a plurality of second gears 520 provided in the power transmission shaft 510 and connected with the plurality of first gears 440 by the connecting member 450, and a plurality of second bearing housings 530 rotatably supporting the power transmission shaft 510.

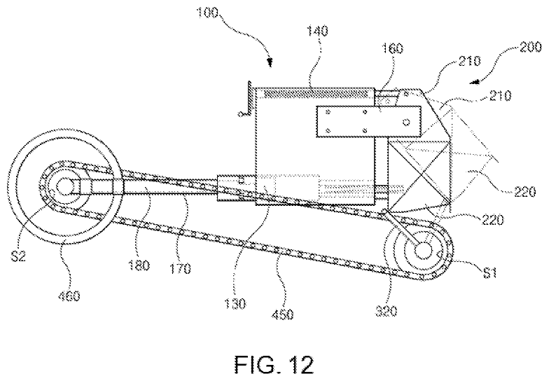

FIG. 12 is a diagram showing a state in which a region of a hammer driving member and a crankshaft portion provided with fly wheels are connected to each other by a connecting portion in the present embodiment shown in FIG. 1.

In the present embodiment, as shown in FIG. 12, the hammer driving member 320 is operated by the rotational force of the crankshaft 420 by connecting a first sprocket S1 to the hammer driving member 320, providing a second sprocket S2 in the crankshaft 420 (see FIG. 2) of the crankshaft portion 400 including the fly wheel 460 and then connecting the first sprocket S1 and the second sprocket S2 by the aforementioned connecting member 450 to hit the hammer member 220.

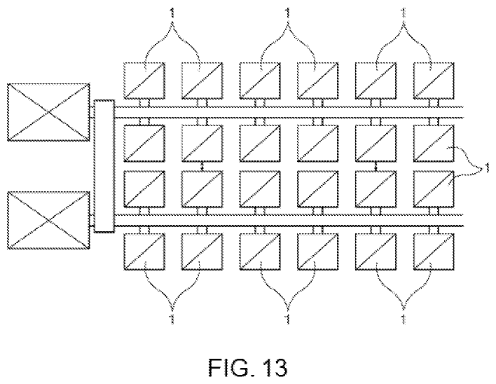

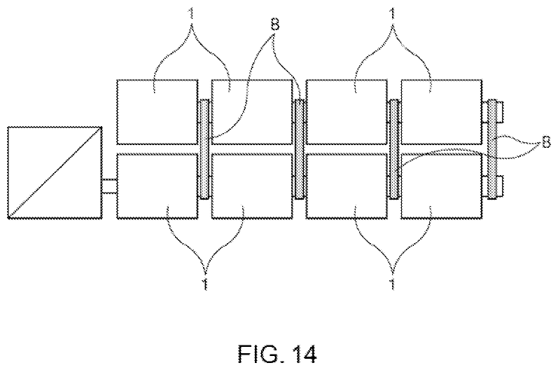

FIG. 13 is a diagram schematically showing a state in which a plurality of present embodiments are connected to each other to provide a power generating plant and FIG. 14 is a diagram schematically showing a state in which the present embodiments used for power generation are connected to each other by a belt.

In the present embodiment, as shown in FIG. 13, a plurality of power generating apparatuses 1 may be connected to an automatic gear clutch and used as a power plant.

Also, in the present embodiment, as shown in FIG. 14, a pair of power generating apparatuses 1 is connected to a belt member B to produce electric energy.

As described above, according to the embodiments of the present invention, when the first inner connecting rod of the main body is hit by rotating the hammer portion by the hammer driving portion, the crankshaft is rotated by the operating fluid stored in the main body and an elastic force of the spring to operate the power generator, thereby minimizing the consumption of the fuel and producing the electric power.

The present invention is not limited to the exemplary embodiments described herein, and it would be apparent to those skilled in the art that various changes and modifications might be made without departing from the spirit and the scope of the present invention. Therefore, it will be determined that the changed examples or modified examples are included in the appended claims of the present invention.

What is claimed is:

1. A power generating apparatus using a hammer comprising:
a main body including a base body in which an operating fluid is stored, a first inner connecting rod provided to be movable at one side of the base body, and a spring provided at the other side of the base body;
a hammer portion of which one side is rotatably coupled to the main body to hit the first inner connecting rod and the other side is connected to the spring;
a hammer driving portion which hits the first inner connecting rod by the hammer portion to provide power;
a crankshaft portion which rotates by receiving a force for hitting the hammer portion by the hammer driving portion; and
a power transmission portion which is connected to the crankshaft portion to rotate together with the crankshaft and connected to a power generator.

2. The power generating apparatus of claim 1, wherein the main body further includes:
a second inner connecting rod which is movably provided in the base body and receives the force of the first inner connecting rod by the operating fluid stored in the base body;
a connecting rod of which one side is provided in the base body to receive the force of the second inner connecting rod and the other side is connected to the crankshaft; and
a spring pressing member of which one side is connected to the hammer portion and the other side is provided in the base body to transmit a force for contracting the spring to the spring when the hammer portion rotates.

3. The power generating apparatus of claim 2, wherein the main body further includes:
a support which supports a lower portion of the base body; and
a connecting rod housing which is coupled to the base body to support the connecting rod.

4. The power generating apparatus of claim 2, wherein the hammer portion includes:
a hammer connecting rod of which one side is connected to the spring pressing member and the other side is rotatably connected to the support provided in the base body; and
a hammer member which is provided at the lower portion of the hammer connecting rod to hit the first inner connecting rod.

5. The power generating apparatus of claim 4, wherein the hammer driving portion includes:
a hammer driving body disposed below the hammer member; and
a hammer driving member which is rotatably provided in the hammer driving body and rotated by the power generated by the driving body to rotate the hammer member.

6. The power generating apparatus of claim 2, wherein the crankshaft portion includes:
a crankshaft support body spaced apart from the base body;
a crankshaft which is rotatably coupled to the upper portion of the crankshaft support body;
a plurality of first bearing housings which is coupled to the crankshaft support body to rotatably support the crankshaft;
a plurality of first gears provided in the crankshaft; and
a plurality of fly wheels provided in the crankshaft.

7. The power generating apparatus of claim 6, wherein the power transmission portion includes:
a power transmission shaft connected to the power generator;
a plurality of second gears which is provided in the power transmission shaft and connected with the plurality of first gears by a connecting member; and
a plurality of second bearing housings which rotatably supports the power transmission shaft.
